(19) United States
(12) Patent Application Publication
(10) Pub. No.: US 2025/0185711 A1
(43) Pub. Date: Jun. 12, 2025

(54) AEROSOL PROVISION SYSTEM

(71) Applicant: NICOVENTURES TRADING LIMITED, London (GB)

(72) Inventor: Patrick MOLONEY, London (GB)

(21) Appl. No.: 19/061,237

(22) Filed: Feb. 24, 2025

Related U.S. Application Data
(63) Continuation of application No. 17/594,016, filed on Sep. 30, 2021.

(30) Foreign Application Priority Data
Apr. 5, 2019 (GB) 1904842.0

(51) Int. Cl. A24F 40/42; A24F 40/20; A24F 40/46; A24F 40/60

(52) U.S. Cl. CPC A24F 40/42; A24F 40/20; A24F 40/46; A24F 40/60

(57) ABSTRACT

There is provided an aerosol provision system comprising: aerosol generating medium; and a source of energy for heating, wherein the source of energy for heating is configured to cause heating of the aerosol generating medium to form an aerosol, wherein the aerosol generating medium is configured to move within the device between a first position in which the aerosol generating medium is positioned a first distance from the source of energy for heating and is heated by the source of energy for heating and a second position in which the aerosol generating medium is positioned at a second distance from the source of energy for heating, wherein the first distance is smaller than the second distance.

### PRIORITY CLAIM

The present application is a Continuation of U.S. patent application Ser. No. 17/594,016 filed Sep. 30, 2021, which is a National Phase entry of PCT Application No. PCT/GB2020/050705, filed Mar. 18, 2020, which claims priority from Great Britain Application No. 1904842.0, filed Apr. 5, 2019, each of which is hereby fully incorporated herein by reference.

### TECHNICAL FIELD

The present invention relates to an aerosol provision system, a method of generating an aerosol in an aerosol provision device, a consumable for use in an aerosol provision device and an aerosol provision device.

### BACKGROUND

Aerosol provision devices are known. Common devices use heaters to create an aerosol from a suitable medium which is then inhaled by a user. Often suitable media require significant levels of heating prior to generating an aerosol for inhalation. Similarly, current devices offer users a large variety in the media from which inhalable aerosol can be generated.

Various approaches are described herein which seek to help address or mitigate at least some of the issues discussed above.

### SUMMARY

Aspects of the invention are defined in the accompanying claims.

In accordance with some embodiments described herein, there is disclosed an aerosol provision system comprising: aerosol generating medium; and a source of energy for heating, wherein the source of energy for heating is configured to cause heating of the aerosol generating medium to form an aerosol, wherein the aerosol generating medium is configured to move within the device between a first position in which the aerosol generating medium is positioned a first distance from the source of energy for heating and is heated by the source of energy for heating and a second position in which the aerosol generating medium is positioned at a second distance from the source of energy for heating, wherein the first distance is smaller than the second distance.

In accordance with some embodiments described herein, there is disclosed a consumable part for an aerosol provision system.

In accordance with some embodiments described herein, there is provided aerosol provision means comprising: aerosol generating means; and heating means, wherein the heating means is configured to cause heating of the aerosol generating means to form an aerosol, wherein the source of aerosol generating means is configured to move within the device between a first position in which the aerosol generating means is positioned a first distance from the source of energy for heating and is heated by the heating means and a second position in which the aerosol generating means is positioned at a second distance from the heating means, wherein the first distance is smaller than the second distance.

In accordance with some embodiments described herein, there is provided a method of generating an aerosol in an aerosol provision system, the method comprising: providing aerosol generating medium; and providing a source of energy for heating; moving the aerosol generating medium from a first position in which the aerosol generating medium is positioned a first distance from the source of energy for heating and is heated by the source of energy for heating to a second position in which the aerosol generating medium is positioned at a second distance from the source of energy for heating, wherein the first distance is smaller than the second distance.

In accordance with some embodiments described herein, there is provided an aerosol provision device configured to receive aerosol generating medium, comprising: a source of energy for heating, wherein the source of energy for heating is configured to, in use, heat aerosol generating medium to form an aerosol, wherein the aerosol provision device is configured, in use, to move the aerosol generating medium between a first position in which the aerosol generating medium is positioned at a first distance from the source of energy for heating and is heated by the source of energy for heating and a second position in which the aerosol generating medium is positioned at a second distance from the source of energy for heating, wherein the second distance is smaller than the first distance.

### BRIEF DESCRIPTION OF THE DRAWINGS

The present teachings will now be described by way of example only with reference to the following figures in which like parts are depicted by like reference numerals:

FIG. 1 is a schematic sectional view of a portion of an aerosol provision system according to an example;

FIG. 2 is a schematic sectional view of a portion of an aerosol provision system according to an example;

FIG. 3 is a schematic sectional view of a portion of an aerosol provision system according to an example;

FIG. 4 shows schematic views of a heater and a source of aerosol generating medium according to a number of examples; and,

FIG. 5 is a schematic sectional view of a portion of an aerosol provision system according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapor”, and related terms such as “vaporize”, “volatilize” and “aerosolize”, may generally be used interchangeably.

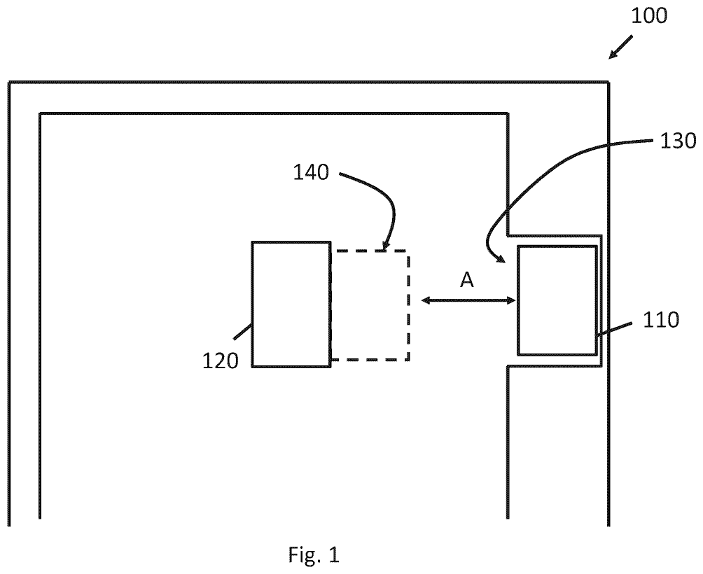

FIG. 1 illustrates a schematic view of a portion of an aerosol provision system 100. The system (occasionally referred to as device herein) 100 has a source of aerosol generating medium 110 (which comprises or consists of aerosol generating medium) within the device 100. The device 100 has a source of energy for heating 120 (occasionally referred to as a heater) configured to cause heating of the aerosol generating medium to form an aerosol. The source 110 is configured to move within the device 100 between a second position (stowed position) 130 away from the heater 120 and a first position (aerosol generating position) 140 in which the source of aerosol generating medium 110 is in contact with the source of energy for heating 120 (or heater). The heater 120 may be configured to heat the aerosol generating medium either directly or indirectly.

The source of aerosol generating medium 110 may include aerosol generating medium in the form of portions or doses 114 of aerosol generating medium. The terms portion and dose may be used interchangeably throughout this description. It is intended to mean a part of the whole aerosol generating medium.

The source of aerosol generating medium 110 may take any suitable form or construction. In one embodiment, the source of aerosol generating medium may include a substrate (for example, paper, card, foil) including a first and second side, with the aerosol generating medium disposed on the first side of the substrate. The substrate in this instance may act as a carrier for the aerosol generating medium. In some implementations, the substrate may be, or may include, a metallic element that is arranged to be heated by a varying magnetic field. In such implementations, the source of energy for heating 120 may include an induction coil, which, when energized, causes heating within the metallic element of the source 110. The degree of heating may be affected by the distance between the metallic element and the induction coil. In yet further alternative implementations, the source of aerosol generating medium 110 may consist entirely (or substantially entirely) of aerosol generating medium (i.e., without a carrier). For the purposes of describing a concrete example, the source 110 described herein includes a substrate with aerosol generating medium disposed on the first side of the substrate, while the source of energy for heating 120 is herein a resistive heater.

As shown in FIG. 1, the source 110 may move along a direction shown by arrow A between the stowed position 130 and the aerosol generating position 140. The heater 120 is a movement-restricted heater 120. The heater 120 is restricted from moving within the device 100 towards the stowed position 130. “Toward” in this context is taken to mean directly towards, rather than in any direction wherein the distance between the heater 120 and the stowed position 130 is reduced. The heater 120 is prevented from moving on an axis, the axis being aligned with the stowed position 130 and the heater 120. The axis on which the heater 120 is prevented from moving along is indicated by arrow A in FIG. 1.

During periods of non-operation of the device 100, the source 110 is maintained in the stowed position 130. The stowed position 130 may be, as shown in FIG. 1, located between two sections of housing of the device 100. The stowed position 130 may be a groove or a sheltered cavity or the like within the device 100. The stowed position 130 is a protected position within the device 100 which may protect the source 110 from, for example, being damaged during transit of the device 100. The protection may be provided by elements or features of the housing of the device 100 as shown in FIG. 1. The protection may be provided by sheltering or covering the source 110 in some manner, for example by covering a majority of the source 110. There may be only one route into and out of the stowed (second) position 130 along the axis of movement of the source 110. In another arrangement (not shown), the device 100 may have a door or cover which is closable when the source 110 is in the stowed position 130 so as to provide a full covering of the source 110. The door may automatically close over the entrance to the stowed position 130 when the source 110 is moved into the stowed position 130 through the entrance to the stowed position 130.

The aerosol generating (first) position 140, shown by a position marked out by a dashed line in FIG. 1, is a position wherein the heater 120 is able to cause heating of the source 110. The heater 120 and source 110 may be proximal, adjacent or abutting while in the aerosol generating position 140. The source 110 may be arranged downstream, in the context of the flow of air through the device, of the heater 120 so that aerosol generated by the heater 120 from the source 110 flows away from the heater 120. This arrangement reduces the likelihood of aerosol condensing on the heater 120 and therefore increases the cleanliness of operation of the device 100. In turn, this increases the lifetime of the heater 120 and therefore reduces the cost of maintenance of the device 100.

In the aerosol generating position 140 the distance between the aerosol generating medium of the source 110 and the source of energy for heating 120 may be controlled (kept the same or otherwise) to provide for a more consistent user experience. In an example the aerosol generating medium is positioned at a distance from the source of energy for heating 120 within the range of 0.010 mm, 0.015 mm, 0.017 mm, 0.020 mm. 0.023 mm, 0.025 mm, 0.05 mm, 0.075 mm, 0.1 mm, to about 4 mm, 3.5 mm, 3 mm, 2.5 mm, 2.0 mm, 1.5 mm, 1.0 mm, 0.5 mm or 0.3 mm. In some cases, there may be a minimum spacing between the source of energy for heating 120 and the aerosol generating medium 110 of at least about 10 μm, 15 μm, 17 μm, 20 μm, 23 μm, 25 μm, 50 μm, 75 μm or 0.1 mm. These distances may include the thickness of the substrate of the source 110. In other examples, the source of energy for heating 120 and the aerosol generating medium may be in direct contact, therefore at a distance of 0.000 mm. In implementations where the source of energy for heating 120 contacts the source of aerosol generating medium 110, the source of energy for heating 120 may actively compress at least a part of the source of aerosol generating medium 110 (which may cause a decrease in the thickness of the source of aerosol generating medium 110 in the vicinity of the application of the compression force as compared to a non-compressed state). This may further increase the efficiency of thermal transfer.

The source 110 may be moved into the aerosol generating position 140 prior to or on initiation of a smoking session. The movement of the source 110 may be automated or may occur on user request. The automation of the movement of the source 110 may be achieved using, for example, a puff detector. Upon detection of a puff by the user, the source 110 may be moved from the stowed position 130 to the aerosol generating position 140. The device 100 may have detectors or sensors located in, for example, the mouthpiece of the device 100 such that when the user places the device 100 in their mouth, the source 110 is moved from the stowed position 130 to the aerosol generating position 140. Alternatively, the mouthpiece (or other component connected to the source 110) could be movable so as to affect movement of the source 110. The mouthpiece may have an element, such as a biased member, such as a tensioned spring, which is affected by placement of the mouthpiece into the user's mouth which provides movement, directly or indirectly, to the source 110. The mouthpiece and housing of the device 100 may be slidably moveable in relation to one another, such that movement of the mouthpiece directly moves the source 110 to abut the heater 120. The device 100 may alternatively or additionally have a button, or the like, which a user may press to instruct the movement of the source 110 from the stowed position 130 to the aerosol generating position 140. Activation of the heater 120 may occur prior to, in tandem with, or with a delay from, the movement of the source 110.

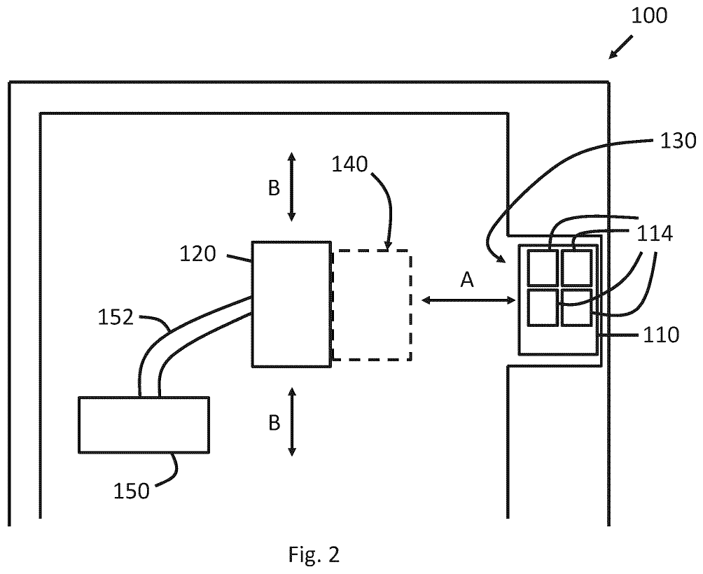

FIG. 2 illustrates a schematic view of a portion of an aerosol provision device 100. Reference numerals indicating the same features as shown in FIG. 1 are the same as those numerals used in FIG. 1. These same features will not be discussed in detail here. FIG. 2 shows an aerosol provision device 100 comprising a heater movement mechanism 150. The source 110 shown in FIG. 2 has a plurality of doses 114 of aerosol generating medium. The doses 114 may be disposed on the surface of the substrate of the source 110 or arranged within the source 110. The heater movement mechanism 150 is configured to move the heater 120 at least on an axis which, in the example shown in FIG. 2, is indicated by the arrows B. The heater movement mechanism 150 includes a link 152 to the heater 120 to facilitate movement of the heater 120. The link 152 may be an element which enables movement of the heater 120, such as a shaft which is connected to a motor. The link 152 may be a mechanical link 152 which may co-operate with other elements such as rails, biased members, or a pulley system to enable movement of the heater 120. The movement of the heater 120 is along an axis that is not parallel with the axis along which the source 110 may move between the stowed position 130 and the aerosol generating position 140. The heater 120 may be configured to move on an axis that is not aligned with the stowed position 130 and the heater 120. As shown in FIG. 2, the arrows A and B are arranged at an angle. In the specific example shown in FIG. 2, arrows A and B are set substantially perpendicular to one another.

The heater 120 may be moved prior to or on initiation of a smoking session. As discussed above with reference to the source 110, puff detectors or sensors or the like may be used to automate the movement and/or activation of the heater 120 so that the heater 120 is in a position to provide heat to the source 110 as and when such heat is required. Alternatively, the device 100 may have a user-activatable button to initiate a smoking sequence which includes moving the heater 120 by the movement mechanism 150. The heater 120 may be moved in a mechanical manner as a result of the mouthpiece being placed into the mouth of the user etc.

The heater 120 may be activated prior to movement along the axis shown by arrow B. This activation may occur in response to detection by a puff sensor of initiation of a smoking session or activation of a user-activatable button as described above. The device 100 may have a controller to control movement and heating phases, to maximize user experience.

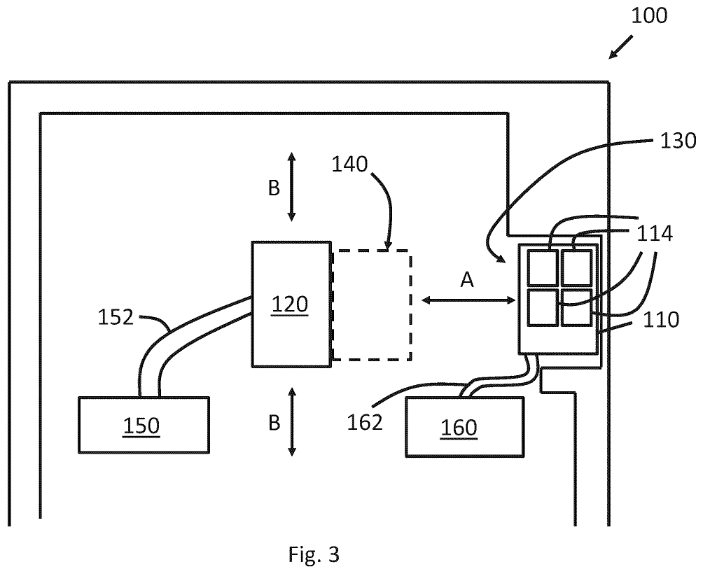

FIG. 3 illustrates a schematic view of a portion of an aerosol provision device 100. Reference numerals indicating the same features as shown in FIGS. 1 and 2 are the same as those numerals used in FIGS. 1 and 2. These same features will not be discussed in detail here. FIG. 3 shows an aerosol provision device 100 comprising a source movement mechanism 160. The source movement mechanism 160 is configured to move the source 110 at least on an axis as indicated in the example of FIG. 3 by the arrow A. Although not shown explicitly in FIG. 3, in this implementation, the source 110 may include a planar section or be substantially planar, and movement of the source 110 along axis A may include movement of the source along the normal to the planar section of the source 110. That is, the normal to the planar section is parallel, or substantially parallel, to axis A. The source movement mechanism 160 includes a link 162 to the source 110 to enable movement of the source 110. The link 162 may be an element which enables movement of the source 110, such as a shaft connected to a motor. The link 162 may be a mechanical link 162 which may co-operate with other elements such as rails, biased members, or a pulley system to facilitate movement of the source 110.

The source movement mechanism 160 is shown, in the example of FIG. 3, located in a position which is near both the stowed position 130 and the aerosol generating position 140. In an example, the source movement mechanism 160 may be positioned in a cavity in which the stowed position 130 is located. In another example, the source movement mechanism 160 may be positioned near the aerosol generating position 140. The source movement mechanism 160 may be arranged on the axis as shown by the arrow A. For example, the source movement mechanism 160 may be arranged on an opposite side of the source 110 to the aerosol generating position 140 along the axis shown by arrow A.

Either heater movement mechanism 150 or source movement mechanism 160 may be a motor or other driving system or may be a biased member or the like. The mechanisms 150, 160 may be an arrangement of cams, cogs, bearings, shafts or the like. The movement provided may be consistent in speed or varied in speed. The movement may enable quick movement of the source 110 towards the aerosol generating position 140, so as to provide aerosol to a user quickly upon activation, and slow movement to the stowed position 130 so that the source 110 is carefully stowed. This may assist in prolonging the longevity of the system 100 as a result of avoiding mechanical collisions.

The source 110 may comprise a single dose of aerosol generating medium or a number of separate doses 114 of aerosol generating medium. In implementations with a plurality of doses, each dose 114 may be separately heatable to produce a predetermined amount of aerosol per use. The doses 114 may be arranged on a substrate so as to be individual and separate within or on the source 110 or may overlap or be adjacent (i.e. the different does may comprise different areas of a single region of aerosol generating medium). Each of the plurality of doses 114 may be separately heatable using respective ones of a corresponding plurality of heaters 120 or by relative translational movement between a heater 120 and doses 114 of aerosol generating medium to align different doses 114 with the heater 120 at different times.

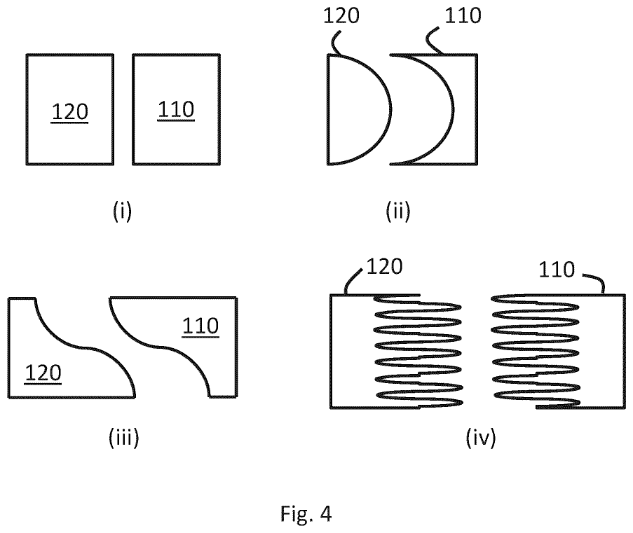

FIG. 4 shows a schematic view of four source 110 and heater 120 combinations. The example shown in FIG. 4 (i) shows a rectangular source 110 and a rectangular heater 120. The view may be a cross-section or a side view of the source 110 and heater 120. FIG. 4 (i) illustrates a complementary combination of shapes for the source 110 and heater 120. The heater 120 may abut the source 110 so that air gaps are not present and do not develop between the source 110 and heater 120 when the source 110 is in the aerosol-generating position 140. Air gaps are undesirable as trapped air requires heating prior to heat energy being received by the source 110 such that aerosol can be generated. This is an inefficient way to heat the source 110 and therefore to be avoid.

FIG. 4 (ii) shows a curved source 110 and a complementarily curved heater 120. The source 110 is curved in a concave manner, while the heater 120 is curved in a convex manner. The contacting surface area on the source 110 and heater 120 is greater than in the example shown in FIG. 4 (i). As such, the heat transferal will be more efficient in the example shown in FIG. 4 (ii). This reduces the time required for an aerosol to be generated during heating of the source 110. In turn, this improves user experience of the device 100. In other implementations, the source 110 may not be curved in a concave manner but when the convex heater 120 engages with the source 110, the source 110 may be compressed by the convex heater 120 to form a concave shape in the source 110.

The radius of curvature for the convex heater 120 may be formed relative to one or multiple axes. For example, the heater may be substantially cuboidal with a semi-cylindrical section (i.e., the radius of curvature is formed with respect to one axis (through the longitudinal part) of the heater 120). Alternatively, the heater may be domed or crown shaped (i.e., the radius of curvature is formed with respect to multiple axes). A domed shape for a heater 120 improves heat transfer from heater 120 to a complementarily-shaped source 110. Furthermore, a circular or domed heater shape offers the advantage of reducing localized areas of stress within the source 110 when the heater 120 is pressed into the source 110 which may cause tearing of the source 110.

FIG. 4 (iii) shows a curved source 110 and a complementarily curved heater 120 with a different curvature to that shown in FIG. 4 (ii). The contacting surface area between the heater 120 and the source 110 is, as with FIG. 4 (ii), increased with respect to the configuration of FIG. 4 (i). As mentioned above, this increases heat transfer and therefore reduces the time required to generate an aerosol from the source 110. Further shapes can be envisaged, however manufacturing complexity should be considered alongside any attempt to simply maximize contacting surface area. Close but deep oscillations of a heater 120, the like of which is shown in FIG. 4 (iv), could result in very high contact surface area, however this would increase complexity of manufacture and would require high accuracy in alignment of both the heater 120 and source 110.

The heater 120 can be moved so as to abut and press against, to apply pressure to, the source 110 of aerosol generating medium. This further improves heat transfer and slight compression of the source 110 further improves heat transfer and therefore efficiency of the device 100. This may increase the lifetime of the battery of the device 100, and can reduce power usage. The arrangement of FIG. 4 (iv) may be unsuitable for compression of the source 110 as the projections on both the heater 120 and the source 110 will result in concentrated areas stress and may be more prone to fracturing or breaking. Furthermore, misalignment of the projections during movement to the heating could lead to tearing of the source 110 or breaking of the heater 120. As mentioned above, a dome shape offers advantages relating to reducing localized areas of stress within the source 110 such that greater compression may be used with less risk of damaging the source 110 than with other types of complementary shapes. During the compression, the source 110 may deform.

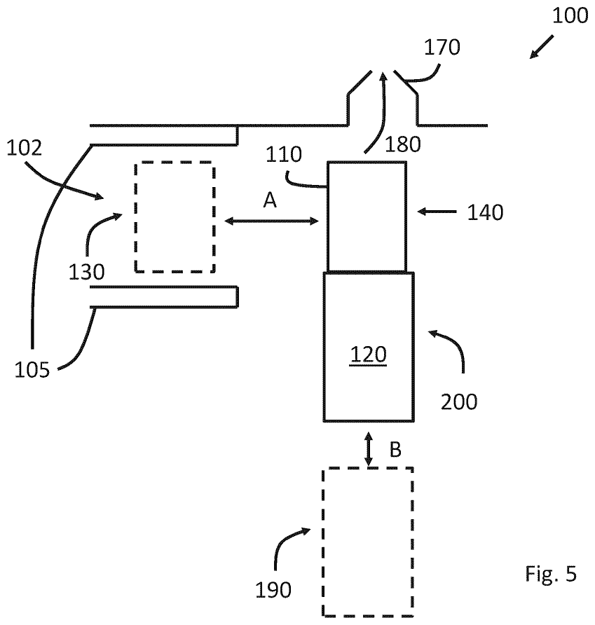

FIG. 5 illustrates a schematic view of a portion of an aerosol provision device 100. Reference numerals indicating the same features as shown in FIGS. 1, 2 and 3 are the same as those numerals used in FIGS. 1, 2 and 3. These same features will not be discussed in detail here. FIG. 5 shows an aerosol provision device 100 comprising an aerosol outlet 170 and a flow path illustrated by the arrow 180. The movement of the source 110 from stowed position 130 to aerosol generating position 140 is shown. The stowed position 130 is shown to be located in a cavity 102 formed by housing elements 105. The movement of the heater 120 from a non-contacting position 190 to a contacting position 200 is also shown. The movements of both the source 110 and the heater 120, prior to generating an aerosol, are shown as being substantially towards the aerosol outlet 170.

An advantage of this arrangement is that the flow path 180 is reduced by an amount related to the distances moved by the source 110 and the heater 120. Reduction of the flow path 180 reduces the number of components (or the exposed surface(s) of a given component) on which the generated aerosol can condense. This improves the cleanliness of the functioning of the device 100 and increases the lifetime of components on which the aerosol would otherwise land and therefore, in some manner, damage.

In the arrangement shown in FIG. 5 the source 110 is kept in the stowed position 130 near the housing of the device 100. The advantage of this arrangement is that it is structurally simple to provide a user with access to the cavity 102 in which the source 110 is stowed. Once the source 110 is depleted, the user may then easily access the cavity 102 to remove and replace the depleted source 110 with a fresh source 110. The addition of a door to provide access for a user to the cavity 102 would be sufficient to achieve this advantage. Such a door may be prevented from being opened during heating periods or periods of movement of the source 110 or heater 120, so as to provide a safe user experience.

Furthermore, the heater 120 is positioned in the contacting location 200 during heating periods. Once no more heat is required to generate an aerosol, the heater 120 may be moved to the non-contacting location 190. In the example shown in FIG. 5, the non-contacting location 190 is located further away from the outer of the device 100. This arrangement is advantageous as the heater 120 provides no more thermal energy near the housing of the device 100 than is required to generate an aerosol from source 110. This movement away from the housing of the device 100 ensures that the housing is less likely to get hot following aerosol generation from the source 110. This avoids a situation wherein the housing gets hot which can be very uncomfortable for a user.

The angle between the axes of movement, shown by arrows A and B, for the source 110 and the heater 120 can be seen in FIG. 5 to be substantially 90°. In other examples, the angle may be at least 20°, at least 25°, at least 30°, at least 35°, at least 40°, at least 45°, at least 50°, at least 55°, at least 60°, at least 65°, at least 70°, at least 75°, at least 80°, or at least 85°.

The source 110 may move or be moved in other directions or dimensions. This movement may be affected by the source movement mechanism 160 or a different movement mechanism. In an example the source 110 may rotate around an axis. The source 110 may rotate around an axis substantially in the direction shown by arrow A. The source 110 may rotate around a set angle between each set of movements from the stowed position 130 to the aerosol generating position 140 and back to the stowed position 130. In this way, a different part of the source 110 and, if the source 110 comprises a number of doses 114, a different dose 114 of the source 110 may be presented to the heater 120 each time the source 110 is moved to the aerosol generating position 140.

The source 110 in FIG. 2 has a number (4) of doses 114 of aerosol generating medium. The source 110 may not have any doses 114 but rather be a single dose 114 itself or otherwise. In some examples, the doses 114 may be in the form of blocks or a disc, which may be continuous or discontinuous, disposed on a surface of, or within, the source 110. In other examples, the doses 114 may be in the form of an annulus, a ring or any other shape. The source 110 may or may not have a rotationally symmetrical distribution of doses 114 on the surface of the source 110. A symmetrical distribution of doses 114 would enable equivalently positioned doses 114 (within the rotationally symmetrical distribution) to receive an equivalent heating profile from the heater 120 upon rotation around the axis A, if desired. There is clearly no requirement for a certain distribution of doses 114 within or on the source 110.

The device 100 may have a plurality of chambers or regions that may or may not be separate from one another. The device 100 may have a power chamber (not shown) comprising a power source for supplying power to the source of energy for heating 120 and/or the movement mechanisms 150, 160. The source of energy for heating 120 in the described example is an electrically resistive heater 120. However, in other examples, the source of energy for heating 120 may be a chemically activated heater 120 which may or may not operate via exothermic reactions or the like. The source of energy for heating 120 may be part of an inductive heating system, wherein the source of energy for heating 120 is the source of energy for inductive heating and the aerosol forming medium may contain a susceptor or the like. The susceptor may for example be a sheet of aluminum foil or the like. For the purposes of providing a concrete example, the source of energy for heating 120 is herein described as a resistive heater, but it should be appreciated that references different heaters or heating system components are envisaged for use in the present device.

The source 110 or the doses 114 contained within the source 110 of aerosol generating medium may comprise at least one of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder. The doses 114 may be separated, adjacent or overlapping.

The aerosol-forming layer described herein comprises an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosol-forming layer comprises from about 50 wt %, 60 wt % or 70 wt % of amorphous solid, to about 90 wt %, 95 wt % or 100 wt % of amorphous solid. In some cases, the aerosol-forming layer consists of amorphous solid.

In some cases, the amorphous solid may comprise 1-50 wt % of a gelling agent wherein these weights are calculated on a dry weight basis.

Suitably, the amorphous solid may comprise from about 1 wt %, 5 wt %, 10 wt %, 15 wt %, 20 wt % or 25 wt % to about 50 wt %, 45 wt %, 40 wt %, 35 wt %, 30 wt % or 27 wt % of a gelling agent (all calculated on a dry weight basis). For example, the amorphous solid may comprise 5-40 wt %, 10-30 wt % or 15-27 wt % of a gelling agent.

In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the amorphous solid. In some cases, the amorphous solid may comprise a calcium-crosslinked alginate and/or a calcium-crosslinked pectin.

Suitably, the amorphous solid may comprise from about 5 wt %, 10 wt %, 15 wt %, or 20 wt % to about 80 wt %, 70 wt %, 60 wt %, 55 wt %, 50 wt %, 45 wt % 40 wt %, or 35 wt % of an aerosol generating agent (all calculated on a dry weight basis). The aerosol generating agent may act as a plasticizer. For example, the amorphous solid may comprise 10-60 wt %, 15-50 wt % or 20-40 wt % of an aerosol generating agent. In some cases, the aerosol generating agent comprises one or more compound selected from erythritol, propylene glycol, glycerol, triacetin, sorbitol and xylitol. In some cases, the aerosol generating agent comprises, consists essentially of or consists of glycerol. The inventors have established that if the content of the plasticizer is too high, the amorphous solid may absorb water resulting in a material that does not create an appropriate consumption experience in use. The inventors have established that if the plasticizer content is too low, the amorphous solid may be brittle and easily broken. The plasticizer content specified herein provides an amorphous solid flexibility which allows the amorphous solid sheet to be wound onto a bobbin, which is useful in manufacture of aerosol generating articles.

In some cases, the amorphous solid may comprise a flavor. Suitably, the amorphous solid may comprise up to about 60 wt %, 50 wt %, 40 wt %, 30 wt %, 20 wt %, 10 wt % or 5 wt % of a flavor. In some cases, the amorphous solid may comprise at least about 0.5 wt %, 1 wt %, 2 wt %, 5 wt % 10 wt %, 20 wt % or 30 wt % of a flavor (all calculated on a dry weight basis). For example, the amorphous solid may comprise 10-60 wt %, 20-50 wt % or 30-40 wt % of a flavor. In some cases, the flavor (if present) comprises, consists essentially of or consists of menthol. In some cases, the amorphous solid does not comprise a flavor.

In some cases, the amorphous solid additionally comprises a tobacco material and/or nicotine. For example, the amorphous solid may additionally comprise powdered tobacco and/or nicotine and/or a tobacco extract. In some cases, the amorphous solid may comprise from about 1 wt %, 5 wt %, 10 wt %, 15 wt %, 20 wt % or 25 wt % to about 70 wt %, 60 wt %, 50 wt %, 45 wt % or 40 wt % (calculated on a dry weight basis) of a tobacco material and/or nicotine.

In some cases, the amorphous solid comprises a tobacco extract. In some cases, the amorphous solid may comprise 5-60 wt % (calculated on a dry weight basis) of tobacco extract. In some cases, the amorphous solid may comprise from about 5 wt %, 10 wt %, 15 wt %, 20 wt % or 25 wt % to about 55 wt %, 50 wt %, 45 wt % or 40 wt % (calculated on a dry weight basis) tobacco extract. For example, the amorphous solid may comprise 5-60 wt %, 10-55 wt % or 25-55 wt % of tobacco extract. The tobacco extract may contain nicotine at a concentration such that the amorphous solid comprises 1 wt % 1.5 wt %, 2 wt % or 2.5 wt % to about 6 wt %, 5 wt %, 4.5 wt % or 4 wt % (calculated on a dry weight basis) of nicotine. In some cases, there may be no nicotine in the amorphous solid other than that which results from the tobacco extract.

In some embodiments the amorphous solid comprises no tobacco material but does comprise nicotine. In some such cases, the amorphous solid may comprise from about 1 wt %, 2 wt %, 3 wt % or 4 wt % to about 20 wt %, 15 wt %, 10 wt % or 5 wt % (calculated on a dry weight basis) of nicotine. For example, the amorphous solid may comprise 1-20 wt % or 2-5 wt % of nicotine.

In some cases, the total content of tobacco material, nicotine and flavor may be at least about 1 wt %, 5 wt %, 10 wt %, 20 wt %, 25 wt % or 30 wt %. In some cases, the total content of tobacco material, nicotine and flavor may be less than about 70 wt %, 60 wt %, 50 wt % or 40 wt % (all calculated on a dry weight basis).

In some embodiments, the amorphous solid is a hydrogel and comprises less than about 20 wt % of water calculated on a wet weight basis. In some cases, the hydrogel may comprise less than about 15 wt %, 12 wt % or 10 wt % of water calculated on a wet weight basis (WWB). In some cases, the hydrogel may comprise at least about 2 wt % or at least about 5 wt % of water (WWB).

The amorphous solid may be made from a gel, and this gel may additionally comprise a solvent, included at 0.1-50 wt %. However, the inventors have established that the inclusion of a solvent in which the flavor is soluble may reduce the gel stability and the flavor may crystalize out of the gel. As such, in some cases, the gel does not include a solvent in which the flavor is soluble.

The amorphous solid comprises less than 20 wt %, suitably less than 10 wt % or less than 5 wt % of a filler. The filler may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives. In some cases, the amorphous solid comprises less than 1 wt % of a filler, and in some cases, comprises no filler. In particular, in some cases, the amorphous solid comprises no calcium carbonate such as chalk.

In some cases, the amorphous solid may consist essentially of, or consist of a gelling agent, an aerosol generating agent, a tobacco material and/or a nicotine source, water, and optionally a flavor.

In the examples above, the source 110 may have a base or coating or the like, which is substantially impermeable to aerosol. This arrangement may encourage the aerosol generated from heating of the source 110 of aerosol generating medium to flow away from the heater 120 and along the flow path 180 towards the outlet 170. This can help reduce the likelihood of condensation of aerosol within the device 100 and, as mentioned above, therefore increases both the cleanliness and lifetime of the device 100. The base may be formed of at least one of materials such as nicotine-containing material, tobacco, or tobacco derivative or the like.

The substrate of the source 110 may be impermeable to aerosol or may be porous such that the aerosol generating medium may be located in the pores of the substrate 110. In an example, the substrate of the source 110 may have permeable and impermeable portions. Permeable portions may be located in portions wherein it is desirable to have aerosol pass through the substrate, such as to allow flow through the substrate of the source 110 and towards the outlet of the device 100. Impermeable portions may be located in portions wherein it is desirable to prevent aerosol flowing towards the source of energy for heating 120.

Thus there has been described an aerosol provision device comprising: a source of aerosol generating medium; and a heater; wherein the heater is configured to cause heating of the aerosol generating medium to form an aerosol; wherein the source is configured to move within the device between a stowed position away (remote) from the heater and an aerosol generating position in which the source of aerosol generating medium is in contact with the heater.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future

1. An aerosol provision system comprising:
an aerosol generating medium;
a source of energy for heating, wherein the source of energy for heating is configured to cause heating of the aerosol generating medium to form an aerosol,
a first movement mechanism; and
a second movement mechanism,
wherein the first movement mechanism is configured to move the aerosol generating medium within the system along a first axis, wherein the first axis extends between a first position in which the aerosol generating medium is positioned a first distance from the source of energy for heating and in which the aerosol generating medium is heated by the source of energy for heating and a second position in which the aerosol generating medium is positioned at a second distance from the source of energy for heating, wherein the first distance is smaller than the second distance, and
wherein the second movement is configured to move the source of energy for heating between a heating position from which the aerosol generating material is heated and a non-heating position, and the movement is at least on a second axis that is at least initially not parallel to the first axis, wherein the aerosol generating medium moves along the first axis, between said first and second positions.

2. An aerosol provision system according to claim 1, wherein the first distance is a distance of less than or equal to about 4 mm; and/or
wherein the first distance is a distance of greater than or equal to about 0.010 mm.

3. An aerosol provision system according to claim 1, wherein the source of energy for heating is restricted from moving within the device towards the second position.

4. An aerosol provision system according to claim 1, wherein the first movement mechanism is user-activatable.

5. An aerosol provision system according to claim 1, arranged such that, in the first position, the aerosol generating medium is compressed by the source of energy for heating.

6. An aerosol provision system according to claim 1, wherein the aerosol generating medium comprises a plurality of portions of aerosol generating medium.

7. An aerosol provision system according to claim 1, wherein the aerosol generating medium and the source of energy for heating are arranged for complementary abutment.

8. An aerosol provision system according to claim 1, wherein the source of energy for heating has substantially rounded edges oriented towards the aerosol generating medium.

9. An aerosol provision system according to claim 1, wherein the source of energy for heating has a shape that is one of domed or crowned.

10. An aerosol provision system according to claim 1, wherein the aerosol provision system comprises a control unit and a replaceable consumable part, wherein the consumable part comprises the aerosol generating medium.

11. An aerosol provision system according to claim 1, wherein the second movement mechanism is configured to move the source of energy for heating at least on the second axis that is substantially perpendicular to the first axis; and/or
wherein the second movement mechanism is user-activatable.

12. An aerosol provision system according to claim 1, wherein the source of energy for heating provides thermal energy by the conversion to thermal energy of at least one of electrical energy and chemical energy.

13. A method of generating an aerosol in an aerosol provision system, the method comprising:
providing aerosol generating medium;
providing a source of energy for heating;
providing a first movement mechanism; and
providing a second movement mechanism,
the first movement mechanism moves the aerosol generating medium along a first axis from a first position in which the aerosol generating medium is positioned a first distance from the source of energy for heating and in which the aerosol generating medium is heated by the source of energy for heating to a second position in which the aerosol generating medium is positioned at a second distance from the source of energy for heating, wherein the first distance is smaller than the second distance; and
the second movement mechanism moves the source of energy for heating between a heating position from which the aerosol generating medium is heated and a non-heating position, and the movement is at least on a second axis that is at least initially not parallel to the first axis, wherein the aerosol generating medium moves along the first axis, between said first and second positions.

14. A method according to claim 13, further comprising heating the aerosol generating medium by the source of energy for heating in the first position to form an aerosol.

15. A method according to claim 13, further comprising restricting movement of the source of energy for heating within the device towards the second position.

16. A method according to claim 13, further comprising compressing, by the source of energy for heating, the aerosol generating medium in the first position, prior to forming an aerosol.

17. A method according to claim 13, wherein moving the aerosol generating medium from the second position to the first position occurs in response to a user command.

18. An aerosol provision device configured to receive aerosol generating medium, comprising:
a source of energy for heating, wherein the source of energy for heating is configured to, in use, heat aerosol generating medium to form an aerosol,
a first movement mechanism; and
a second movement mechanism,
wherein the aerosol provision device is configured, in use, for the first movement mechanism to move the aerosol generating medium along a first axis between a first position in which the aerosol generating medium is positioned at a first distance from the source of energy for heating and in which the aerosol generating medium is heated by the source of energy for heating and a second position in which the aerosol generating medium is positioned at a second distance from the source of energy for heating, wherein the second distance is smaller than the first distance, and
the aerosol provision device is configured, in use, for the second movement mechanism to move the source of energy for heating between a heating position from which the aerosol generating material is heated and a non-heating position, and the movement is at least on a second axis that is at least initially not parallel to the first axis, wherein the aerosol generating medium moves along the first axis, between said first and second positions.
